(19) United States
(12) Patent Application Publication
(10) Pub. No.: US 2015/0063090 A1
(43) Pub. Date: Mar. 5, 2015

(54) METHOD FOR RECEIVING SIGNAL IN WIRELESS COMMUNICATION SYSTEM AND APPARATUS THEREFOR

(71) Applicant: ELECTRONICS & TELECOMMUNICATIONS RESEARCH INSTITUTE, Daejeon (KR)

(72) Inventor: Yong Su LEE, Daejeon (KR)

(21) Appl. No.: 14/475,820

(22) Filed: Sep. 3, 2014

(30) Foreign Application Priority Data
Sep. 4, 2013 (KR) 10-2013-0105796

(51) Int. Cl. H04L 27/26; H04L 25/02

(52) U.S. Cl. CPC H04L 27/2627; H04L 25/0202; H04L 27/2656; H04L 27/2666
USPC 370/210

(57) ABSTRACT

Disclosed are methods and apparatuses for receiving signals in a wireless communication system. The method may comprise identifying a frame start point based on a received signal; determining a fast Fourier transform (FFT) start point based on the frame start point; reconfiguring the FFT start point in order for the FFT start point to be located within a cyclic prefix (CP) period based on a preconfigured offset value; performing FFT based on the reconfigured FFT start point; and performing, on a result of the FFT, a phase compensation based on the preconfigured offset value. Thus, degradation of channel estimation performances can be prevented.

### CLAIM FOR PRIORITY

This application claims priority to Korean Patent Application No. 10-2013-0105796 filed on Sep. 4, 2013 in the Korean Intellectual Property Office (KIPO), the entire contents of which are hereby incorporated by references.

### BACKGROUND

1. Technical Field

Example embodiments of the present invention relate to a technology for receiving signal in a wireless communication system, and more specifically to methods and apparatuses for receiving signal which can compensate degradation of channel estimation performance due to time synchronization error.

2. Related Art

In a wireless communication system based on orthogonal frequency division multiplexing (OFDM), a receiving end identifies a frame start point or a symbol start point after acquiring reception time synchronization, and uses data located in corresponding positions according to the identified start point.

When a time synchronization error exists, there may be a problem of reception performance degradation. However, OFDM-based wireless communication systems may be tolerant of reception timing synchronization error. That is, even though the time synchronization error exists, if a fast Fourier transform (FFT) is performed at a start point within a cyclic prefix (CP) period, reception performance may not be degraded. In this case, even when a simple least square (LS) method is used for channel estimation, reception performance may not be degraded.

On the contrary, since OFDM-based wireless communication systems may be vulnerable to inter-carrier interference (ICI), when FFT is performed at a start point within a data period not a CP period, a problem of reception performance degradation due to the ICI may occur.

### SUMMARY

Accordingly, example embodiments of the present invention are provided to substantially obviate one or more problems due to limitations and disadvantages of the related art.

Example embodiments of the present invention provide methods for receiving signals, which can compensate degradation of channel estimation performance through phase compensation in frequency axis.

Example embodiments of the present invention also provide apparatuses for receiving signals, which can compensate degradation of channel estimation performance through phase compensation in frequency axis.

In some example embodiments, a method for receiving signal may comprise identifying a frame start point based on a received signal; determining a fast Fourier transform (FFT) start point based on the frame start point; reconfiguring the FFT start point in order for the FFT start point to be located within a cyclic prefix (CP) period based on a preconfigured offset value; performing FFT based on the reconfigured FFT start point; and performing, on a result of the FFT, a phase compensation based on the preconfigured offset value.

Here, the method may further comprise performing channel estimation on the result of the phase compensation by applying a least square (LS) method.

Here, in the reconfiguring the FFT start point, the FFT start point may be moved toward the CP period by the preconfigured offset value.

Here, in the performing the phase compensation, a reciprocal of a phase generated according to the preconfigured offset value may be multiplied to the result of FFT.

Here, the preconfigured offset value may have a smaller value than a length of the CP period.

In other example embodiments, an apparatus for receiving signal may comprise a synchronization acquiring part identifying a frame start point based on a received signal; a start point configuring part determining a fast Fourier transform (FFT) start point based on the frame start point and reconfiguring the FFT start point in order for the FFT start point to be located within a cyclic prefix (CP) period based on a preconfigured offset value; a FFT part performing FFT based on the reconfigured FFT start point; and a phase compensating part performing, on a result of the FFT, a phase compensation based on the preconfigured offset value.

Here, the apparatus may further comprise a channel estimating part performing channel estimation on the result of the phase compensation by applying a least square (LS) method.

Here, the start point configuring part may move the FFT start point toward the CP period by the preconfigured offset value.

Here, the phase compensating part may perform the phase compensation by multiplying a reciprocal of a phase generated according to the preconfigured offset value and the result of FFT.

Here, the preconfigured offset value may have a smaller value than a length of the CP period.

According to the present invention, degradation of channel estimation performance can be prevented by performing phase compensation in frequency axis after performing FFT.

### BRIEF DESCRIPTION OF DRAWINGS

Example embodiments of the present invention will become more apparent by describing in detail example embodiments of the present invention with reference to the accompanying drawings, in which:

FIG. 1 is a block diagram illustrating an apparatus for receiving signal according to an example embodiment of the present invention;

FIG. 2 is a conceptual diagram illustrating a FFT start point according to an example embodiment of the present invention;

FIG. 3 is a graph illustrating performance of a signal receiving apparatus according to an example embodiment of the present invention;

FIG. 4 is a flow chart illustrating a method for receiving signals according to another example embodiment of the present invention;

FIG. 5 is a conceptual diagram illustrating a start point of FFT according to another example embodiment of the present invention;

FIG. 6 is a block diagram illustrating an apparatus for receiving signal according to another example embodiment of the present invention; and

FIG. 7 is a graph illustrating performance of a signal receiving apparatus according to another example embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present invention will be described in detail with reference to the accompanying drawings. To aid in understanding the present invention, like numbers refer to like elements throughout the description of the drawings, and the description of the same element will not be reiterated.

In a wireless communication system according to example embodiments of the present invention which will be described below, methods and apparatuses for receiving signals may be applied to a wireless communication system based on an orthogonal frequency division multiplexing (OFDM).

Here, an apparatus for receiving signal may be referred to as a receiving end in a wireless communication system, for example, a part of a terminal or a terminal itself. In this case, methods for receiving signal, according to the present invention, may be performed in a terminal.

The term “terminal” used in this specification may be referred to as User Equipment (UE), a User Terminal (UT), a wireless terminal, an Access Terminal (AT), a Subscriber Unit (SU), a Subscriber Station (SS), a wireless device, a wireless communication device, a Wireless Transmit/Receive Unit (WTRU), a mobile node, a mobile, or other words.

The terminal may be a cellular phone, a smart phone having a wireless communication function, a Personal Digital Assistant (PDA) having a wireless communication function, a wireless modem, a portable computer having a wireless communication function, a photographing device such as a digital camera having a wireless communication function, a gaming device having a wireless communication function, a music storing and playing appliance having a wireless communication function, an Internet home appliance capable of wireless Internet access and browsing, or also a portable unit or terminal having a combination of such functions. However, the terminal is not limited to the above-mentioned units.

Meanwhile, a signal receiving apparatus may receive signals transmitted from a transmitting end in a wireless communication system, and the transmitting end may be a base station. Here, the term “base station” used in this specification means a fixed point that communicates with terminals, and may be referred to as another word, such as Node-B, eNode-B, a base transceiver system (BTS), an access point, etc. Also, the term “base station” means a controlling apparatus which controls at least one cell. In a real wireless communication system, a base station may be connected to and controls a plurality of cells physically, in this case, the base station may be regarded to comprise a plurality of logical base stations. That is, parameters configured to each cell are assigned by the corresponding base station.

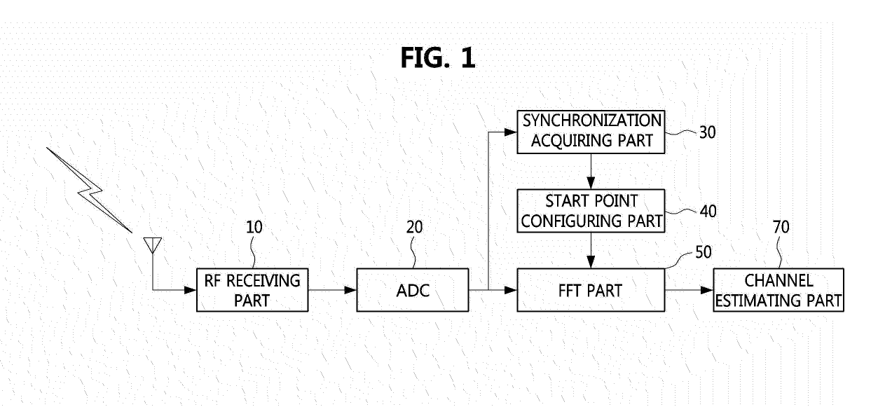

FIG. 1 is a block diagram illustrating an apparatus for receiving signal according to an example embodiment of the present invention.

Referring to FIG. 1, a signal receiving apparatus in a wireless communication system may comprise a radio frequency (RF) receiving part 10, an analog-to-digital converter (ADC) 20, a synchronization acquiring part 30, a start point configuring part 40, a fast Fourier transform (FFT) part 50, and a channel estimating part 70. Here, the signal receiving apparatus may mean a receiving end in an OFDM-based wireless communication system.

The RF receiving part 10 may receive signals transmitted from an arbitrary transmitting end, and provide the received signals to the ADC 20. The ADC 20 may mean an analog-to-digital converter which can convert the received signals in analog form into digital signals. The ADC 20 may provide the converted digital signals to the synchronization acquiring part 30 and the FFT part 50.

The synchronization acquiring part 30 may identify a frame start point based on the received digital signals. For example, in a wireless communication system based on long term evolution (LTE), the synchronization acquiring part 30 may acquire a frame synchronization (that is, a start point of a downlink frame) of a cell based on a primary synchronization signal (PSS) and a secondary synchronization signal (SSS). Then, the synchronization acquiring part 30 may provide the acquired frame start point to the start point configuring part 40. The start point configuring part 40 may determine a FFT start point based on the acquired frame start point, and reconfigure the FFT start point based on a preconfigured offset value so that the FFT start point can be located within a cyclic prefix (CP) period.

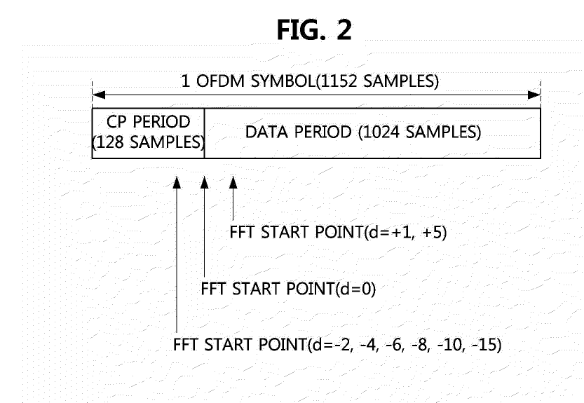

FIG. 2 is a conceptual diagram illustrating a FFT start point according to an example embodiment of the present invention.

Referring to FIG. 2, in an OFDM-based wireless communication system, an OFDM symbol may have a CP period and a data period. For example, if a symbol has a length of 1152 samples, the CP period may have a length of 128 samples and the data period may have a length of 1024 samples.

The start point configuring part 40 may determine the FFT start point based on the acquired frame start point initially with an offset value 0. Then, the start point configuring part 40 may move the FFT start point toward the CP period by a preconfigured offset value. For example, if the preconfigured offset value is −10 (i.e. d=−10), the start point configuring part 40 may move the FFT start point toward the CP period by 10 samples. Also, if the preconfigured offset value is −15 (i.e. d=−15), the start point configuring part 40 may move the FFT start point toward the CP period by 15 samples. On the contrary, if the preconfigured offset value is +5 (i.e. d=+5), the start point configuring part 40 may move the FFT start point toward the data period by 5 samples.

Here, the offset value 0 may correspond to a start point of the data period, and the offset value −10 may correspond to a point which is moved toward the CP period from the start point of the data period by 10 samples, and the offset value −15 may correspond to a point which is moved toward the CP period from the start point of the data period by 15 samples, and the offset value +5 may correspond to a point which is moved toward the data period from the start point of the data period by 5 samples.

As described above, by moving the ITT start point toward the CP period with a preconfigured offset value, inter-carrier interference (ICI) may be reduced. Accordingly, reception performance may be enhanced in a receiving end of a wireless communication system.

Re-referring to FIG. 1, the start point configuring part 40 may provide information on the reconfigured FFT start point to the FFT part 50. The FFT part 50 may perform FFT at the reconfigured FFT start point located within the CP period. Then, the FFT part 50 may provide the result of FFT to the channel estimating part 70.

The channel estimating part 70 may perform channel estimation based on the result of FFT. Here, the channel estimating part 70 may perform channel estimation by using one of various channel estimation methods (e.g. a least square (LS) method)).

Here, the functions of the synchronization acquiring part 30, the start point configuring part 40, the FFT part 50, and the channel estimating part 70 may be performed in a processing part. The processing part may include a processor and a memory. The processor may be a general purpose processor (e.g. a central processing unit) or a dedicated processor designed for processing the functions of the above parts. Program codes for the function of the above parts may be stored in the memory. That is, the processor can read the program codes stored in the memory, and execute the program codes in order to perform the functions of the above parts.

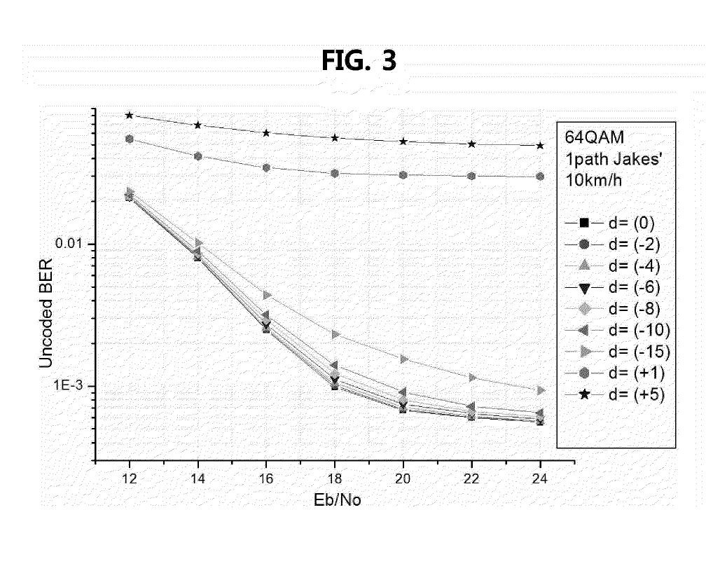

FIG. 3 is a graph illustrating performance of a signal receiving apparatus according to an example embodiment of the present invention.

Referring to FIG. 3, reception performances of the signal receiving apparatus are illustrated when a 64 quadrature amplitude modulation (QAM) is used. In FIG. 3, a horizontal axis represents a ratio (i.e. Eb/No) of bit energy (Eb) and noise (No), and a vertical axis represents an uncoded bit error ratio (BER).

When the apparatus according to the present invention is used, it can be known that reception performance may vary significantly in accordance with the FFT start point (d).

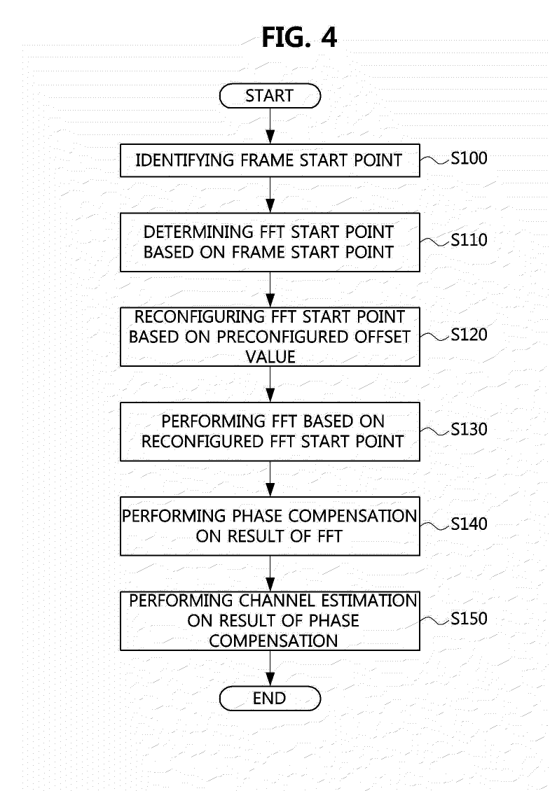

FIG. 4 is a flow chart illustrating a method for receiving signals according to another example embodiment of the present invention.

Referring to FIG. 4, a signal receiving method according to the present invention may comprise a step S100 of identifying a frame start point based on a received signal; a step S110 of determining a fast Fourier transform (FFT) start point based on the frame start point; a step S120 of reconfiguring the FFT start point in order for the FFT start point to be located within a cyclic prefix (CP) period based on a preconfigured offset value; a step S130 of performing FFT based on the reconfigured FFT start point; and a step S140 of performing, on a result of the FFT, a phase compensation based on the preconfigured offset value. In addition, the signal receiving method may further comprise a step S150 of performing channel estimation by applying a least square method to the result of the phase compensation.

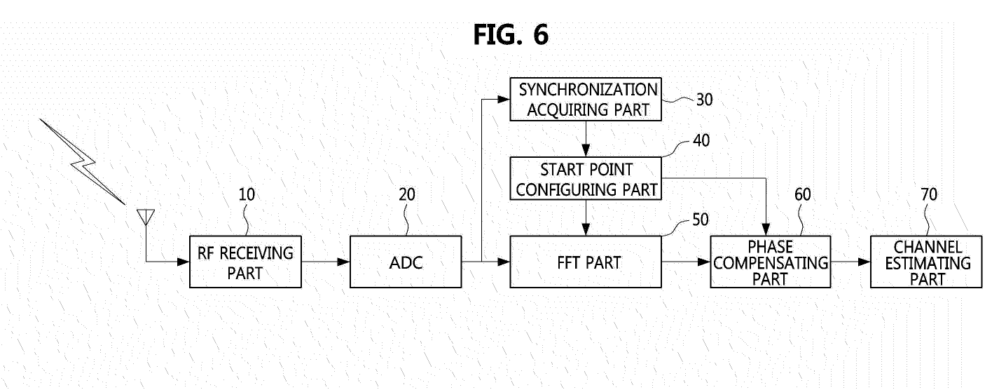

The method for receiving signals may be performed in a signal receiving apparatus illustrated in FIG. 6. FIG. 6 is a block diagram illustrating an apparatus for receiving signal according to another example embodiment of the present invention. The apparatus may comprise the RF receiving part 10, the ADC 20, the synchronization acquiring part 30, the start point configuring part 40, the FFT part 50, and a phase compensating part 60. In addition, the apparatus may further comprise the channel estimating part 70.

The apparatus may identify a frame start point based on received signals (S100). For example, in a wireless communication system based on long term evolution (LTE), the apparatus may acquire a frame synchronization (that is, a start point of a downlink frame) of a cell based on a primary synchronization signal (PSS) and a secondary synchronization signal (SSS).

Also, the apparatus may determine a FFT start point based on the acquired frame start point (S110). Then, the apparatus may reconfigure the FFT start point based on a preconfigured offset value so that the start point of FFT can be located within a cyclic prefix (CP) period (S120).

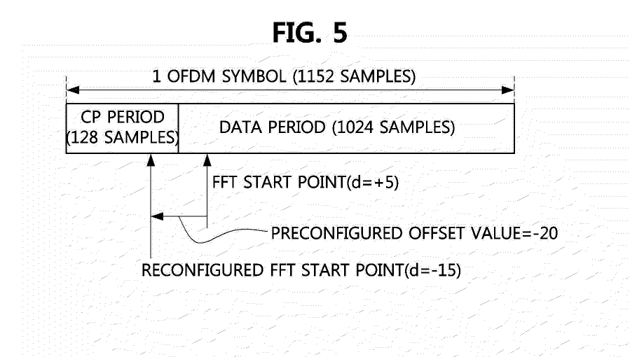

FIG. 5 is a conceptual diagram illustrating a start point of FFT according to another example embodiment of the present invention.

Referring to FIG. 5, in an OFDM-based wireless communication system, an OFDM symbol may have a CP period and a data period. For example, if a symbol has a length of 1152 samples, the CP period may have a length of 128 samples and the data period may have a length of 1024 samples.

In the step S110, the apparatus may determine a frame start point (d=+5) as the FFT start point. Here, the initial FFT start point may be a position moved by 5 samples from a start point of the data period. In the step S120, if a preconfigured offset value is −20, the apparatus may reconfigure the FFT start point with the preconfigured offset value. That is, the apparatus may move the FFT start point by the preconfigured offset value (−20) toward the CP period. Here, the position corresponding to the offset value −20 may mean a point (d=−15) moved by 15 samples from the start point of the data period toward the CP period.

The preconfigured offset value may vary according to user configurations, and may be a value smaller than a sample length of the CP period. Also, it is preferred that the preconfigured offset value may have a value which can move the initially identified FFT start point so as to locate the reconfigured FFT start point within the CP period.

Re-referring to FIG. 4, the signal receiving apparatus may perform FFT at the reconfigured FFT start point (S130). In other words, the signal receiving apparatus may perform FFT at the reconfigured FFT start point (d=−15) as illustrated in FIG. 5.

The apparatus may perform phase compensation related to the preconfigured offset value on the result of the FFT (S140). That is, the apparatus may perform the phase compensation by multiplying the result of the FFT and a reciprocal of a phase generated according to the preconfigured offset value.

The following equation 1 may represent a phase compensation value.

$$Phase Compensation Value = exp ( \frac{j 2 π \cdot FPSO \cdot k}{N} ) \qquad [ Equation 1 ]$$

Here, FPSO (FFT_START_POINT_OFFSET) means a preconfigured offset value, and k means a subcarrier index, and N means a size of the FFT. The apparatus may perform a phase compensation by multiplying the result of the FFT and the phase compensation value derived from the equation 1.

Then, the apparatus may estimate channel by applying a least square (LS) method to the result of the phase compensation. Here, the apparatus may use a simple LS method.

The example embodiments of the present invention can be implemented in the form of a program command that can be executed through a variety of computer means and recorded in a computer-readable medium. The computer-readable medium may include program commands, data files, data structures, etc. in a single or combined form. The program commands recorded in the computer-readable medium may be program commands that are specially designed and configured for the example embodiments of the present invention, or program commands that are publicized and available for those of ordinary skill in the art of computer software.

Examples of the computer-readable medium include hardware devices, such as a read-only memory (ROM), a random access memory (RAM), and a flash memory, specially configured to store and execute program commands. Examples of the program commands include advanced language codes that can be executed by a computer using an interpreter, etc., as well as machine language codes, such as those generated by a compiler. The hardware devices may be configured to operate as at least one software module so as to perform operations of the example embodiments of the present invention, and vice versa.

FIG. 6 is a block diagram illustrating an apparatus for receiving signal according to another example embodiment of the present invention.

Referring to FIG. 6, a signal receiving apparatus according to another example embodiment of the present invention may comprise the RF receiving part 10, the ADC 20, the synchronization acquiring part 30, the start point configuring part 40, the FFT part 50, the phase compensation part 60, and the channel estimating part 70. As compared to the example embodiment illustrated in FIG. 1, another example embodiment may further comprise the phase compensating part 60.

The RF receiving part 10 may receive signals transmitted from an arbitrary transmitting end, and provide the received signals to the ADC 20. The ADC 20 may mean an analog-to-digital converter which can convert the received signal in analog form into digital signal. The ADC 20 may provide the converted digital signals to the synchronization acquiring part 30 and the FFT part 50.

The synchronization acquiring part 30 may identify a frame start point based on the received digital signal. For example, in a wireless communication system based on long term evolution (LIE), the synchronization acquiring part 30 may acquire a frame synchronization (that is, a start point of a downlink frame) of a cell based on a primary synchronization signal (PSS) and a secondary synchronization signal (SSS). Then, the synchronization acquiring part 30 may provide the acquired frame start point to the start point configuring part 40.

The start point configuring part 40 may determine a FFT start point based on the acquired frame start point, and reconfigure the FFT start point based on a preconfigured offset value so that the FFT start point can be located within a cyclic prefix (CP) period. In the example illustrated in FIG. 5, the start point configuring part 40 may initially determine a frame start point (d=+5) as the FFT start point, and reconfigure the FFT start point so that d becomes −15 value when the preconfigured offset value is −20. Then, the start point configuring part 40 may provide information on the reconfigured FFT start point to the FFT part 50, and provide information on the preconfigured offset value used for reconfiguring the

FFT start point to the phase compensating part 60.

The FFT part 50 may perform FFT at the reconfigured FFT start point. That is, the FFT part 50 may perform FFT at the FFT start point reconfigured as d=−15.

The phase compensating part 60 may perform a phase compensation related to the preconfigured offset value on the result of the FFT. Specifically, the phase compensating part 60 may perform the phase compensation by multiplying the result of the FFT and a reciprocal of a phase generated according to the preconfigured offset value. That is, the apparatus may perform a phase compensation by multiplying the result of the FFT and the phase compensation value derived from the equation 1.

The channel estimating part 70 may estimate channel by applying a least square (LS) method to the result of the phase compensation. Here, the channel estimating part 70 may use a simple LS method.

Here, the functions of the synchronization acquiring part 30, the start point configuring part 40, the FFT part 50, the phase compensating part 60, and the channel estimating part 70 may be performed in a processing part. The processing part may include a processor and a memory. The processor may be a general purpose processor (e.g. a central processing unit) or a dedicated processor designed for processing the functions of the above parts. Program codes for the function of the above parts may be stored in the memory. That is, the processor can read the program codes stored in the memory, and execute the program codes in order to perform the functions of the above parts.

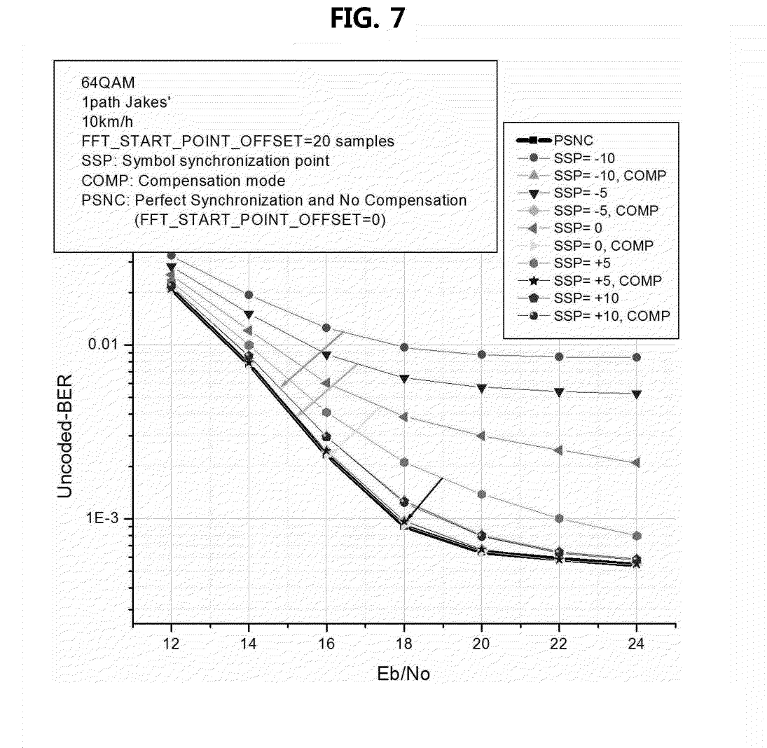

FIG. 7 is a graph illustrating performance of a signal receiving apparatus according to another example embodiment of the present invention.

Referring to FIG. 7, reception performances of the signal receiving apparatus are illustrated when a 64 quadrature amplitude modulation (QAM) is used. In FIG. 7, a horizontal axis represents Eb/No, and a vertical axis represents a uncoded BER. Here, FPSO is set to be 20 samples, and SSP means a symbol synchronization point, and COMP (compensation mode) means cases in which phase compensation related to the preconfigured offset value is performed, and PSNC (perfect synchronization and no compensation) means cases in which a phase compensation is not performed according to a perfect synchronization.

In the graph illustrated in FIG. 7, it can be known that cases of COMP always have smaller BERs than cases of PSNC.

While the example embodiments of the present invention and their advantages have been described in detail, it should be understood that various changes, substitutions and alterations may be made herein without departing from the scope of the invention.

What is claimed is:

1. A method for receiving signal, the method comprising:
identifying a frame start point based on a received signal;
determining a fast Fourier transform (FFT) start point based on the frame start point;
reconfiguring the FFT start point in order for the FFT start point to be located within a cyclic prefix (CP) period based on a preconfigured offset value;
performing FFT based on the reconfigured FFT start point; and
performing, on a result of the FFT, a phase compensation based on the preconfigured offset value.

2. The method of claim 1, further comprising performing channel estimation on the result of the phase compensation by applying a least square (LS) method.

3. The method of claim 1, wherein, in the reconfiguring the FFT start point, the FFT start point is moved toward the CP period by the preconfigured offset value.

4. The method of claim 1, wherein, in the performing the phase compensation, a reciprocal of a phase generated according to the preconfigured offset value is multiplied to the result of FFT.

5. The method of claim 1, wherein the preconfigured offset value has a smaller value than a length of the CP period.

6. An apparatus for receiving signal, the apparatus comprising:
a synchronization acquiring part identifying a frame start point based on a received signal;
a start point configuring part determining a fast Fourier transform (FFT) start point based on the frame start point and reconfiguring the FFT start point in order for the FFT start point to be located within a cyclic prefix (CP) period based on a preconfigured offset value;
a FFT part performing FFT based on the reconfigured FFT start point; and
a phase compensating part performing, on a result of the FFT, a phase compensation based on the preconfigured offset value.

7. The apparatus of claim 6, further comprising a channel estimating part performing channel estimation on the result of the phase compensation by applying a least square (LS) method.

8. The apparatus of claim 6, wherein the start point configuring part moves the FFT start point toward the CP period by the preconfigured offset value.

9. The apparatus of claim 6, wherein the phase compensating part performs the phase compensation by multiplying a reciprocal of a phase generated according to the preconfigured offset value and the result of FFT.

10. The apparatus of claim 6, wherein the preconfigured offset value has a smaller value than a length of the CP period.
